(19) United States
(12) Patent Application Publication
(10) Pub. No.: US 2023/0216615 A1
(43) Pub. Date: Jul. 6, 2023

(54) SINGLE TB TRANSMISSION OVER MULTIPLE SLOTS

(71) Applicant: Telefonaktiebolaget LM Ericsson (publ), Stockholm (SE)

(72) Inventors: Reem KARAKI, Aachen (DE); Jung-Fu CHENG, Fremont, CA (US)

(21) Appl. No.: 17/923,965

(22) PCT Filed: May 7, 2021
(86) PCT No.: PCT/SE2021/050430

§ 371 Date: Nov. 8, 2022

Related U.S. Application Data
(60) Provisional application No. 63/021,824, filed on May 8, 2020.

(51) Int. Cl. H04L 1/1829; H04W 72/232; H04L 1/1867

(52) U.S. Cl. CPC H04L 1/1861; H04W 72/232; H04L 1/1893

(57) ABSTRACT

Methods, systems and apparatuses are disclosed for configuring a network node that communicates with a wireless device (WD) to use at least one of a single physical uplink shared channel or physical downlink shared channel (PXSCH) for a single transport block (TB) transmission that exceeds a single slot. The network node and WD may be further configured to transmit a single TB over multiple PXSCHs with one PXSCH for each slot. Initial transmission of one or more code blocks (CBs) or code block groups (CBG) of a TB may be indicated by the network node of WD with a start length indicator (SLIV). CBs transmitted in one or more PXSCHs may be grouped into one or more CBG groups by the network node or WD and repetition, multi-PUSCH scheduling and single TB transmission over multiple PUSCHs may also be used.

### TECHNICAL FIELD

The present disclosure relates to wireless communications, and in particular, to transmitting a single transport block over multiple time slots.

### BACKGROUND

### New Radio (NR) Numerologies

Similar to 3rd Generation Partnership Project (3GPP) Long-Term Evolution (LTE), New Radio (NR) (also known as “5G”) uses Orthogonal Frequency Division Multiplexing (OFDM) in the downlink (DL) (i.e., from a network node or base station, to a wireless device (WD)). The basic NR physical resource over an antenna port can thus be seen as a time-frequency grid as illustrated in FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element (RE) corresponds to one OFDM subcarrier during one OFDM symbol interval.

Multiple OFDM numerologies, μ, are supported in NR as given by Table 1, where the subcarrier spacing, Δf, and the cyclic prefix for a carrier bandwidth part are configured by different higher layer parameters for downlink and uplink, respectively.

TABLE 1
Supported transmission numerologies.

| | Subcarrier spacing Δf = 2^{μ} · 15[kHz] | | | | | | | | | |
|---|---|---|---|---|---|---|---|---|---|---|
| | 15 kHz | | 30 kHz | | 60 kHz | | 120 kHz | | 240 kHz | |
| Slot duration | 1000 | μs | 500 | μs | 250 | μs | 125 | μs | 62.5 | μs |
| OFDM symbol, | 66.67 | μs | 33.33 | μs | 16.67 | μs | 8.33 | μs | 4.17 | μs |
| duration | | | | | | | | | | |
| Cyclic prefix, | 4.69 | μs | 2.34 | μs | 1.17 | μs | 0.59 | μs | 0.29 | μs |
| duration | | | | | | | | | | |
| OFDM symbol | 71.35 | μs | 35.68 | μs | 17.84 | μs | 8.92 | μs | 4.46 | μs |
| including cyclic | | | | | | | | | | |
| prefix | | | | | | | | | | |
| Max carrier | 50 | MHz | 100 | MHz | 200 | MHz | 400 | MHz | 800 | MHz |
| bandwidth | | | | | | | | | | |
| (assuming 4k | | | | | | | | | | |
| FFT) | | | | | | | | | | |

3GPP NR Release-16 supports subcarrier spacings (SCSs) up to 240 kHz, which can be used for frequencies up to the 52.6 GHz band. For 3GPP Release-17, the 3GPP radio access network (RAN) group has agreed to support NR from 52.6 GHz to 71 GHz. This support includes the following:
Study of required changes to NR using existing DL/uplink (UL) NR waveform to support operation between 52.6 GHz and 71 GHz;
Study of applicable numerology including subcarrier spacing, channel bandwidth (BW) (including maximum BW), and their impact to frequency range 2 (FR2) physical layer design to support system functionality considering practical radio frequency (RF) impairments [RAN1, RAN4];
Identify potential critical problems to physical signal/channels, if any [RAN1]; and
Study of channel access mechanism, considering potential interference to/from other nodes, assuming beam-based operation, in order to comply with the regulatory requirements applicable to unlicensed spectrum for frequencies between 52.6 GHz and 71 GHz [RAN1].

It is noted that potential interference impact, if identified, may require interference mitigation solutions as part of the channel access mechanism. Higher SCSs have been proposed for supporting NR from 52.6 GHz to 71 GHz, e.g., 960 kHz and higher SCSs.

### Slot Structure for NR

In the time domain, downlink and uplink transmissions in NR are organized into equally-sized subframes of 1 ms each similar to LTE. A subframe is further divided into multiple slots of equal duration. The slot length for subcarrier spacing Δf=(15×2\hat{φ}μ) kHz is ½\hat{ }μ ms. There is only one slot per subframe for Δf=15 kHz and a slot consists of 14 OFDM symbols.

An NR slot consists of 14 OFDM symbols. In FIG. 2, Tₛ and T_{symb} denote the slot and OFDM symbol duration, respectively. In addition, the symbols within a slot may be classified as either UL, DL or flexible to accommodate the transient period between DL and UL transmissions and to accommodate both DL and UL transmissions. Potential variations are shown in FIG. 3.

Furthermore, NR also defines mini-slots (referred to as Type B physical downlink shared channel (PDSCH)/physical uplink shared channel (PUSCH) mapping in 3GPP specifications). Mini-slots are shorter than slots and can start at any symbol. Mini-slots are used if the transmission duration of a slot is too long or the occurrence of the next slot start (slot alignment) is too late. Applications of mini-slots include among others latency critical transmissions (in this case both mini-slot length and frequent opportunity of mini-slot are important) and unlicensed spectrum where a transmission should start immediately after listen-before-talk succeeded (here the frequent opportunity of mini-slot is especially important). An example of mini-slots is shown in FIG. 4.

### Time Resource Allocations for PUSCH

When the WD is scheduled to transmit a transport block, the time domain resource assignment field value m of the DCI provides a row index m+1 to an allocated RRC configured table. The indexed row may define:
the slot offset K₂;
the start and length indicator SLIV, or directly the start symbol S and the allocation length L; and/or
the PUSCH mapping type to be applied in the PUSCH transmission.
   The slot where the WD may transmit the PUSCH is determined by K₂ as:

$$⌊ n \cdot \frac{{2}^{{μ}_{PUSCH}}}{{2}^{{μ}_{PDCCH}}} ⌋ + {K}_{2}$$

where n is the slot with the scheduling DCI, K₂ is based on the numerology of PUSCH, and μ_{PUSCH} and μ_{PDCCH} are the subcarrier spacing configurations for PUSCH and PDCCH, respectively.

The starting symbol S relative to the start of the slot, and the number of consecutive symbols L counting from the symbol S allocated for the PUSCH, are determined from the start and length indicator SLIV of the indexed row:

```
if ^{(L-1) ≤ 7} then
  SLIV = 14 · (L − 1) + S
else
  SLIV = 14 · (14 − L + 1) + (14 − 1 − S)
```

where 0<L≤14−S
The WD may consider the S and L combinations defined in Table 2 as valid PUSCH allocations.

TABLE 2
Valid S and L combinations

| PUSCH | Normal cyclic prefix | | | Extended cyclic prefix | | |
|---|---|---|---|---|---|---|
| mapping type | S | L | S + L | S | L | S + L |
| Type A | 0 | {4, . . . , 14} | {4, . . . , 14} | 0 | {4, . . . , 12} | {4, . . . , 12} |
| Type B | {0, . . . , 13} | {1, . . . , 14} | {1, . . . , 14} | {0, . . . , 12} | {1, . . . , 12} | {1, . . . , 12} |

Either a default PUSCH time domain allocation, A, according to Table 3 is applied, or the higher layer configured pusch-AllocationList in either pusch-ConfigCommon or pusch-Config is applied. The value of j depends on the subcarrier spacing and is defined in Table 4 below.

TABLE 3
Default PUSCH time domain resource allocation
A for extended cyclic (CP)

| | PUSCH | | | |
|---|---|---|---|---|
| | mapping | | | |
| Row index | type | K₂ | S | L |
| 1 | Type A | j | 0 | 8 |
| 2 | Type A | j | 0 | 12 |
| 3 | Type A | j | 0 | 10 |
| 4 | Type B | j | 2 | 10 |
| 5 | Type B | j | 4 | 4 |
| 6 | Type B | j | 4 | 8 |
| 7 | Type B | j | 4 | 6 |
| 8 | Type A | j + 1 | 0 | 8 |
| 9 | Type A | j + 1 | 0 | 12 |
| 10 | Type A | j + 1 | 0 | 10 |
| 11 | Type A | j + 2 | 0 | 6 |
| 12 | Type A | j + 2 | 0 | 12 |
| 13 | Type A | j + 2 | 0 | 10 |
| 14 | Type B | j | 8 | 4 |
| 15 | Type A | j + 3 | 0 | 8 |
| 16 | Type A | j + 3 | 0 | 10 |

TABLE 4
Definition of value j

| μ_{PUSCH} | j |
|---|---|
| 0 | 1 |
| 1 | 1 |
| 2 | 2 |
| 3 | 3 |

According to 3GPP Release-15, the pusch-AllocationList can be higher layer configured as follows:

```
  -- ASN1 START
  -- TAG-PUSCH-TIMEDOMAINRESOURCEALLOCATIONLIST-START
PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {
```

| | |
|---|---|
| k2 | INTEGER(0..32) OPTIONAL, -- NeedS |
| mappingType | ENUMERATED {typeA, typeB}, |
| startSymbolAndLength | INTEGER (0..127) |

```
}
  -- TAG-PUSCH-TIMEDOMAINRESOURCEALLOCATIONLIST-STOP
  -- ASN1STOP
```

where the fields may be defined as follows:

k2
Corresponds to L1 parameter ‘K2’ (see 3GPP Technical specification (TS) 38.214 [19], clause 6.1.2.1) When the field is absent the WD applies the value 1 when PUSCH SCS is 15/30 kHz; the value 2 when PUSCH SCS is 60 kHz, and the value 3 when PUSCH SCS is 120 KHz.

mappingType
Mapping type (see 3GPP TS 38.214, clause 6.1.2.1).

startSymbolAndLength
An index giving valid combinations of start symbol and length (jointly encoded) as start and length indicator (SLIV). The network configures the field so that the allocation does not cross the slot boundary. (see 3GPP TS 38.214, clause 6.1.2.1).

### Transport Block Preparation

In the 3GPP NR system specifications, the data transported by the PDSCH or the PUSCH is organized as a transport block (TB). In order to detect whether the transport block is correctly received at the receiver, a cyclic redundancy check (CRC) checksum is appended to the transport block. The total length of the transport block and the CRC checksum needs to be one of the channel codeword lengths (CWL). When the transport block size is small enough to be handled as a single low density parity check (LDPC) codeword, the transport block CRC checksum size is set to 16. An example of the CRC attachment procedure for small transport blocks is illustrated in FIG. 5. Hence, when the transport block size is selected from a table included in the NR specifications.

In modern high data rate communications systems, a large amount of data bits in the transport block can be transmitted by a PDSCH or a PUSCH at a time. Since it is impractical to implement channel codec hardware of very large block lengths, it may be useful to divide a large transport block into multiple smaller units referred to as code blocks (CB), whose sizes can be handled by the channel codec hardware. When a transport block is segmented into several code blocks, additional CRC checksums for the individual code blocks are further added to enable early stopping of the channel decoder and code block group based operations. This two-level CRC attachment procedure is illustrated in FIG. 6. The CRC checksums for the transport block and the code block can in general be of different sizes or computed based on different CRC check equations.

Note that the code block segmentation procedure takes as its input the transport block bits and the associated transport block CRC checksum bits. Hence, the last code block contains the transport block CRC checksum bits as illustrated in FIG. 7.

In the 3GPP NR specification:
If the transport block size is no greater than 3824, no code block segmentation is performed and the transport block CRC checksum size is set to 16;
If the transport block size is greater than 3824, the transport block CRC checksum size is set to 24. Furthermore:
   If the code rate is no greater than 1/4, code block segmentation is performed using LDPC codeword lengths up to 3840 bits;
   Otherwise:
      If the transport block size is no greater than 8424, no code block segmentation is performed; and/or
      If the transport block size is greater than 8424, code block segmentation is performed using low density parity check (LDPC) codeword lengths up to 8448 bits.
         The code block CRC checksum length is always 24 bits in NR.

### Scheduling Approaches

According to 3GPP NR Release-16, the duration of PUSCH/PDSCH transmission does not exceed 14 symbols. An initial transmission of a Transport Block (TB) is confined within a single PUSCH/PDSCH.

The current specification supports different arrangements for scheduling multiple PUSCHs using single DCI, for example:

Mode1: Type A repetition: in the case where the indicated number of slot repetitions is greater than 1, (K)>1, the same symbol allocation (SLIV) may be applied across the K consecutive slots. K2 indicates the slot where the WD may transmit the first PUSCH of the multiple PUSCHs. Each PUSCH carries a full TB, and corresponds to a RV value that depends on the configured RV sequence.

Mode2: Type B repetition: the time domain resource allocation (TDRA) indicates the number of contiguous PUSCH repetitions, K2 indicates the slot where the WD may transmit the first PUSCH of the multiple PUSCHs. S indicates the starting symbol of the first PUSCH, and L is the length of the PUSCH repetitions. Each PUSCH carries a full TB, and corresponds to a RV value that depends on the configured RV sequence.

Mode3: Multiple PUSCH scheduling: the time domain resource allocation (TDRA) indicates allocations for two to eight contiguous PUSCHs, K2 indicates the slot where the WD may transmit the first PUSCH of the multiple PUSCHs. Each PUSCH may have a separate SLIV and mapping type, and carries different TB. The number of scheduled PUSCHs may be signaled by the number of indicated valid SLIVs in the row of the pusch-TimeDomainAllocationList signaled in DCI format 0_1.

### CBG Based Retransmission

3GPP NR supports, in addition to transport block based re-transmissions, Code Block Group (CBG) based re-transmissions to selectively re-transmit parts of the transport block.

The CBGs may be constructed as follows.
The maximum number N of CBG(s) per TB is configured by radio resource control (RRC) signaling:
   The number M of CBG(s) in the TB equals to min(C, N), where C is the number of CB(s) within the TB.
For CBG construction:
   The first Mod(C,M) CBG(s) out of total M CBG(s) include ceil(C/M) CB(s) per CBG;
   The remaining M-Mod(C,M) CBG(s) include floor(C/M) CB(s) per CBG.
For initial transmission and retransmission, each CBG of a TB has the same set of CB(s):
   N=2, 4, 6, or 8 for 1 code word (CW) and N=1, 2, 3, or 4 for 2 CWs.
      A CBG transmission information (CBGTI) field can be configured to be present in the DCI to indicate what CBG(s) to retransmit.

### Channel Coding and Rate Matching for Code Blocks in NR

After code block segmentation, the individual coded blocks are channel encoded and rate match separately. In the NR specification, the total number of coded bits available for transmission of the transport block is denoted by G. These available coded bits available for transmission are divided as evenly as possible amongst the code blocks scheduled for transmission.

Details: Let C′ be the total number of code blocks scheduled for transmission. A first set of code blocks are rate matched to

$$⌊ \frac{G}{{C}^{′} \cdot {Q}_{m} \cdot v} ⌋ \cdot {Q}_{m} \cdot v$$

bits each. A second set of code blocks are rate matched to

$$⌈ \frac{G}{{C}^{′} \cdot {Q}_{m} \cdot v} ⌉ \cdot {Q}_{m} \cdot v$$

bits each. (The number of coded symbols for each of the two sets of code blocks are

$$⌊ \frac{G}{{C}^{′} \cdot {Q}_{m} \cdot v} ⌋ \cdot {Q}_{m} \cdot v$$

symbols and

$$⌈ \frac{G}{{C}^{′} \cdot {Q}_{m} \cdot v} ⌉ \cdot {Q}_{m} \cdot v$$

symbols, respectively.)

The preparation, channel encoding and rate matching for a large transport block transmission over a scheduled slot in NR is summarized in FIG. 7. After transport block CRC attachment, code block segmentation may be performed to produce several code blocks of equal size. After code block CRC attachment, the code blocks may be channel encoded and rate matched to as equal number of coded bits as possible.

The processing delays in terms of symbols as shown in Table 5 below become larger for higher SCS, even though the absolute time might be smaller.

TABLE 5

| | HARQ | 15 kHz | 30 kHz | 60 kHz | 120 kHz |
|---|---|---|---|---|---|
| PDSCH Configuration | Timing | SCS | SCS | SCS | SCS |
| Front-loaded | N1 | 8 | 10 | 17 | 20 |
| DeModulation | | | | | |
| Reference Signal | | | | | |
| (DMRS) only | | | | | |
| Front-loaded + | N1 | 13 | 13 | 20 | 24 |
| additional DMRS | | | | | |
| Frequency-first RE- | N2 | 10 | 12 | 23 | 36 |
| mapping | | | | | |

Note:
N1: # of OFDM symbols from end of PDSCH until beginning of PUCCH
N2: # of OFDM symbols from end of PDCCH (UL grant) until beginning of PUSCH.

The processing delays may have an impact on the scheduling behavior. 3GPP NR operates with limited hybrid automatic repeat request (HARQ) processes. The initial transmission of a TB is confined within a single PUSCH/PDSCH that may not exceed 14 symbols. New data cannot be scheduled unless there is a free HARQ process to be used for the TB transmission, or unacknowledged data has to be discarded.

For higher frequency band using higher SCS (960 kHz or more), hardware implementation constraints would be created to either (1) increase the number of HARQ processes to avoid situations where the transmissions need to be stalled due to lack of free HARQ processes and long delays for processing or (2) reducing the processing time even further.

In practical receiver implementations (the WD for the PDSCH and the network node for the PUSCH), hardware design may have restrictions such that certain units of receiver processing cannot span over a slot boundary. As one nonlimiting example, the encoded bits of a LDPC code block may need to be restricted to within a single slot.

### SUMMARY

Some embodiments advantageously provide methods, systems, and/or apparatuses for enabling single transport block transmissions over durations that may exceed a single slot by means of single or multiple PXSCH scheduling.

Embodiments provide a scheduling solution that addresses long processing delay, especially for high SCS. According to one aspect, a network node configured to communicate with a wireless device (WD). The network node includes processing circuitry configured to: configure a transport block, TB, transmission that exceeds a single slot; and cause the TB transmission over at least one physical uplink shared channel, or physical downlink shared channel, PXSCH, each PXSCH, occupying at least one slot and configured to carry coded bits of the TB.

According to this aspect, in some embodiments, the processing circuitry is further configured to cause transmission of a single TB over multiple PXSCHs with one PXSCH for each slot of a succession of slots. In some embodiments, the processing circuitry is further configured to support an extended set of start, S, and length, L, indicators to yield a PXSCH length longer than fourteen symbols. In some embodiments, S={0, 1, 2 . . . 13} and L={1, 2 . . . Lₘₐₓ} where Lₘₐₓ is predefined or configured by signaling. In some embodiments, Lₘₐₓ is fourteen times a slot aggregation factor, the slot aggregation factor being configured by signaling to the WD. In some embodiments, L is in the union of {1, 2 . . . 14} and {28, 56, 112 . . . Lₘₐₓ}. In some embodiments, the extended set further includes a number A indicating a number of fully allocated slots following the first slot, such that a total number of scheduled orthogonal frequency division multiplexed, OFDM, symbols is determinable by the WD as S+14*A+L. In some embodiments, each PXSCH segment within a slot of a succession of slots has a demodulation reference signal, DMRS, pattern. In some embodiments, each of a first number of PXSCH segments of a PXSCH have a first demodulation reference signal, DMRS, pattern, and subsequent PXSCH segments of the PXSCH have one or more predefined DMRS patterns. In some embodiments, the TB is transmitted over multiple PXSCH with one PXSCH per slot of a succession of slots, each PXSCH carrying a portion of coded bits of the TB. In some embodiments, the processing circuitry is further configured to indicate initial transmission of one or more code blocks, CBs, or code block groups, CBG, of a TB with a start length indicator, SLIV. In some embodiments, the processing circuitry is further configured with repetitions and a single TB over multiple physical uplink shared channels, PUSCH. In some embodiments, the processing circuitry is further configured to configure the WD with Third Generation Partnership Project, 3GPP, Release 16-compatible multiple physical uplink shared channel, PUSCH, scheduling and with a single TB over multiple PUSCHs.

According to another aspect, a method in a network node configured to communicate with a wireless device, WD, is provided. The method includes configuring a transport block, TB, transmission that exceeds a single slot; and causing the TB transmission over at least one physical uplink shared channel or physical downlink shared channel, PXSCH, each PXSCH occupying at least one slot and configured to carry coded bits of the TB.

According to this aspect, in some embodiments, the method further includes causing transmission of a single TB over multiple PXSCHs with one PXSCH for each slot of a succession of slots. In some embodiments, the method also includes supporting an extended set of start, S, and length, L, indicators to yield a PXSCH length longer than fourteen symbols. In some embodiments, S={0, 1, 2 . . . 13} and L={1, 2 . . . Lₘₐₓ} where Lₘₐₓ is predefined or configured by signaling. In some embodiments, Lₘₐₓ is fourteen times a slot aggregation factor, the slot aggregation factor being configured by signaling to the WD. In some embodiments, L is in the union of {1, 2 . . . 14} and {28, 56, 112 . . . Lₘₐₓ}. In some embodiments, the extended set further includes a number A indicating a number of fully allocated slots following the first slot, such that a total number of scheduled orthogonal frequency division multiplexed, OFDM, symbols is determinable by the WD as S+14*A+L. In some embodiments, each PXSCH segment within a slot of a succession of slots has a demodulation reference signal, DMRS, pattern. In some embodiments, each of a first number of PXSCH segments of a PXSCH have a first demodulation reference signal, DMRS, pattern, and subsequent PXSCH segments of the PXSCH have one or more predefined DMRS patterns. In some embodiments, the TB is transmitted over multiple PXSCH with one PXSCH per slot of a succession of slots, each PXSCH carrying a portion of coded bits of the TB. In some embodiments, the method further includes indicating initial transmission of one or more code blocks, CBs, or code block groups, CBG, of a TB with a start length indicator, SLIV. In some embodiments, the method also includes configuring the WD with repetitions and a single TB over multiple physical uplink shared channels, PUSCH. In some embodiments, the method further includes configuring the WD with Third Generation Partnership Project, 3GPP, Release 16-compatible multiple physical uplink shared channel, PUSCH, scheduling and with a single TB over multiple PUSCHs.

According to another aspect, a WD configured to communicate with a network node is provided. The WD includes processing circuitry configured to: configure a transport block, TB, transmission that exceeds a single slot; and cause the TB transmission over at least one physical uplink shared channel, PUSCH, each PUSCH occupying at least one slot and configured to carry coded bits of the TB.

According to this aspect, in some embodiments, the processing circuitry is further configured to cause transmission of a single TB over multiple PUSCHs with one PUSCH for each slot of a succession of slots. In some embodiments, the processing circuitry is further configured to support an extended set of start, S, and length, L, indicators to yield a PUSCH length longer than 14 symbols. In some embodiments, S={0, 1, 2 . . . 13} and L={1, 2 . . . Lₘₐₓ} where Lₘₐₓ is predefined or configured by signaling. In some embodiments, the TB is transmitted over multiple PUSCH with one PUSCH per slot of a succession of slots, each PUSCH carrying a portion of coded bits of the TB.

According to yet another aspect, a method in a wireless device, WD, configured to communicate with a network node is provided. The method includes configuring a transport block, TB, transmission that exceeds a single slot; and causing the TB transmission over at least one physical uplink shared channel, PUSCH, each PUSCH occupying at least one slot and configured to carry coded bits of the TB.

According to this aspect, in some embodiments, the method also includes causing transmission of a single TB over multiple PUSCHs with one PUSCH for each slot of a succession of slots. In some embodiments, the method also includes supporting an extended set of start, S, and length, L, indicators to yield a PUSCH length longer than 14 symbols. In some embodiments, S={0, 1, 2 . . . 13} and L={1, 2 . . . Lₘₐₓ} where Lₘₐₓ is predefined or configured by signaling. In some embodiments, the TB is transmitted over multiple PUSCH with one PUSCH per slot of a succession of slots, each PUSCH carrying a portion of coded bits of the TB.

According to another aspect, a WD configured to communicate with a network node is provided. The WD includes a radio interface configured to: receive a configuration of a hybrid automatic repeat request acknowledgement, HARQ-ACK, feedback group size from the network node; and receive a downlink transmission over multiple slots scheduled by a downlink control information, DCI, message from the network node. The WD also includes processing circuitry configured to generate HARQ-ACK feedback of the size determined by the feedback group size for the downlink transmission. The radio interface is further configured to transmit the generated HARQ-ACK feedback to the network node.

In some embodiments, the HARQ-ACK feedback is provided per code block group, CBG, when the WD is configured with CBG retransmission. In some embodiments, code blocks, CB, of a single transport block, TB, are grouped into code block groups, CBGs. In some embodiments, the processing circuitry is further configured to schedule a single transport block, TB across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

According to yet another aspect, a method in a wireless device, WD, configured to communicate with a network node is provided. The method includes receiving a configuration of a hybrid automatic repeat request acknowledgement, HARQ-ACK, feedback group size from the network node. The method also includes receiving a downlink transmission over multiple slots scheduled by a downlink control information, DCI, message from the network node, generating HARQ-ACK feedback of the size determined by the feedback group size for the downlink transmission, and transmitting the generated HARQ-ACK feedback to the network node.

According to this aspect, in some embodiments, the HARQ-ACK feedback is provided per code block group, CBG, when the WD is configured with CBG retransmission. In some embodiments, code blocks, CB, of a single transport block, TB, are grouped into code block groups, CBGs. In some embodiments, the method also includes scheduling a single transport block, TB across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

According to another aspect, a network node in communication with a wireless device, WD, is provided. The network node includes a radio interface configured to: transmit to the WD a configuration of a hybrid automatic repeat request acknowledgement, HARQ-ACK, feedback group size; transmit a downlink control information, DCI, to schedule an uplink transmission over multiple slots from the WD; and receive the uplink transmission over multiple slots from the WD. The network node also includes processing circuitry configured to generate HARQ-ACK feedback of the size determined by the feedback group size for the uplink transmission, the radio interface further configured to transmit the HARQ-ACK feedback to the WD.

According to this aspect, in some embodiments, the HARQ-ACK feedback is provided per code block group, CBG, when the WD is configured with CBG retransmission. In some embodiments, code blocks, CB, of a single transport block, TB, are grouped into code block groups, CBGs. In some embodiments, the processing circuitry is further configured to schedule a single transport block, TB, across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

According to yet another aspect, a method in a network node in communication with a wireless device, WD, is provided. The method includes transmitting to the WD a configuration of a hybrid automatic repeat request acknowledgement, HARQ-ACK, feedback group size. The method also includes transmitting a downlink control information, DCI, to schedule an uplink transmission over multiple slots from the WD, receiving the uplink transmission over multiple slots from the WD, generating HARQ-ACK feedback of the size determined by the feedback group size for the uplink transmission and transmitting the HARQ-ACK feedback to the WD.

According to this aspect, in some embodiments, the HARQ-ACK feedback is provided per code block group, CBG, when the WD is configured with CBG retransmission. In some embodiments, code blocks, CB, of a single transport block, TB, are grouped into code block groups, CBGs. In some embodiments, the method also includes scheduling a single transport block, TB, across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example NR physical resource grid according to the principles in the present disclosure;

FIG. 2 is a schematic diagram of an example NR slot according to the principles in the present disclosure;

FIG. 3 is a schematic diagram of example NR slot variations according to the principles in the present disclosure;

FIG. 4 is a schematic diagram of an example mini-slot with 2 OFDM symbols according to the principles in the present disclosure;

FIG. 5 is a schematic diagram of an example CRC attachment for small transport blocks according to the principles in the present disclosure;

FIG. 6 is a schematic diagram of an example two-level CRC attachment method for NR code block segmentation according to the principles in the present disclosure;

FIG. 7 is a schematic diagram of an example preparation, channel encoding and rate matching method for a large transport block transmission over a scheduled slot in NR according to the principles in the present disclosure;

FIG. 8 is a schematic diagram of an example network architecture illustrating a communication system connected via an intermediate network to a host computer according to the principles in the present disclosure;

FIG. 9 is a block diagram of a host computer communicating via a network node with a wireless device over an at least partially wireless connection according to some embodiments of the present disclosure;

FIG. 10 is a flowchart illustrating example methods implemented in a communication system including a host computer, a network node and a wireless device for executing a client application at a wireless device according to some embodiments of the present disclosure;

FIG. 11 is a flowchart illustrating example methods implemented in a communication system including a host computer, a network node and a wireless device for receiving user data at a wireless device according to some embodiments of the present disclosure;

FIG. 12 is a flowchart illustrating example methods implemented in a communication system including a host computer, a network node and a wireless device for receiving user data from the wireless device at a host computer according to some embodiments of the present disclosure;

FIG. 13 is a flowchart illustrating example methods implemented in a communication system including a host computer, a network node and a wireless device for receiving user data at a host computer according to some embodiments of the present disclosure;

FIG. 14 is a flowchart of an example process in a network node for using at least one of a single physical uplink shared channel or physical downlink shared channel (PXSCH) for a single transport block (TB) transmission that exceeds a single slot according to some embodiments of the present disclosure;

FIG. 15 is a flowchart of an example process in a wireless device for using at least one of a single physical uplink shared channel or physical downlink shared channel (PXSCH) for a single transport block (TB) transmission that exceeds a single slot according to some embodiments of the present disclosure;

FIG. 16 is a flowchart of another example process in a network node according to principles set forth herein;

FIG. 17 is a flowchart of another example process in a wireless device according to principles set forth herein;

FIG. 18 is a flowchart of yet another example process in a network node according to principles set forth herein;

FIG. 19 is a flowchart of another example process in a wireless device according to principles set forth herein;

FIG. 20 is a schematic diagram of an example of the PUSCH crossing a slot boundary according to some embodiments of the present disclosure;

FIG. 21 is an illustration of the mapping of DMRS patterns for PXSCH segments according to some embodiments of the present disclosure;

FIG. 22 is an illustration of the DMRS pattern for PUSCH length >14 according to some embodiments of the present disclosure;

FIG. 23 is a schematic diagram of the scheduling of the initial transmission of a transport block using a single or multiple DCIs according to some embodiments of the present disclosure; and

FIG. 24 is an illustration of the grouping of the CB(s) transmitted in one or more PXSCHs into one CBG group according to some embodiments of the present disclosure.

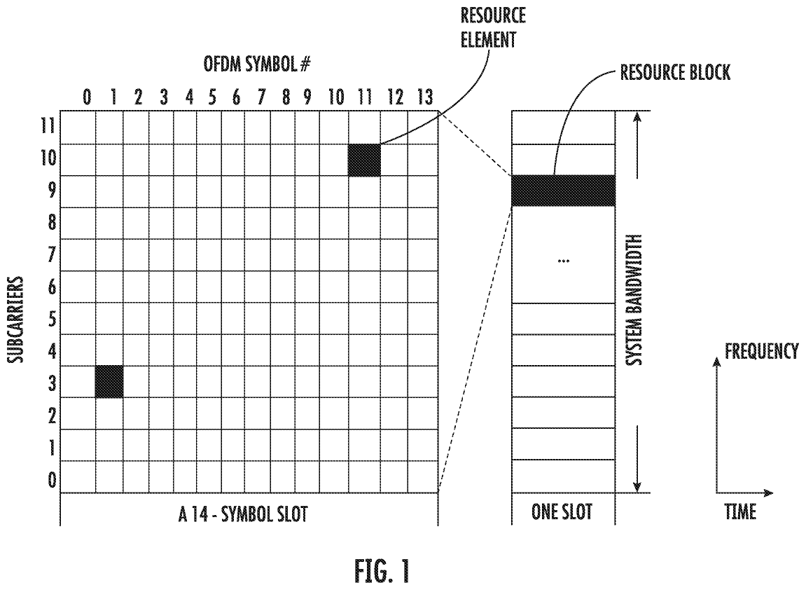

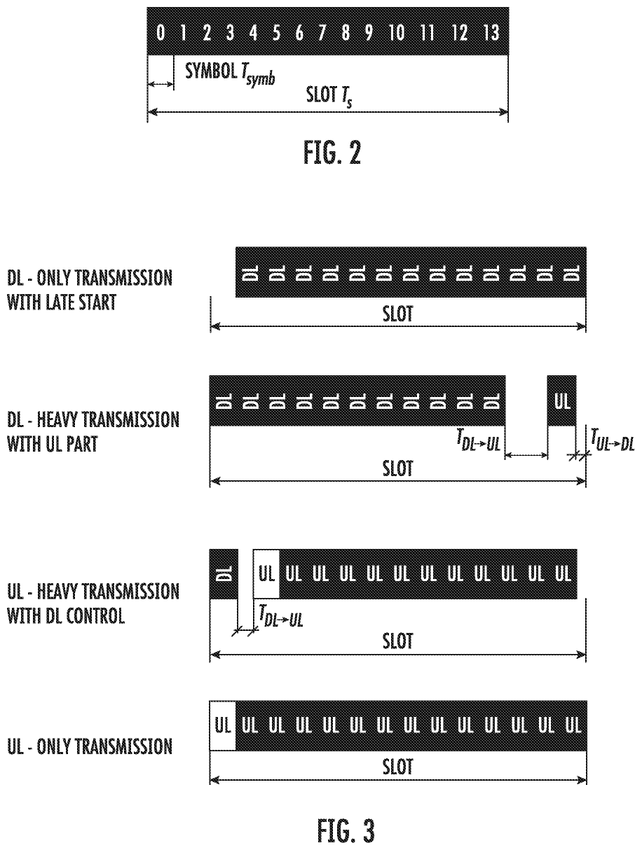

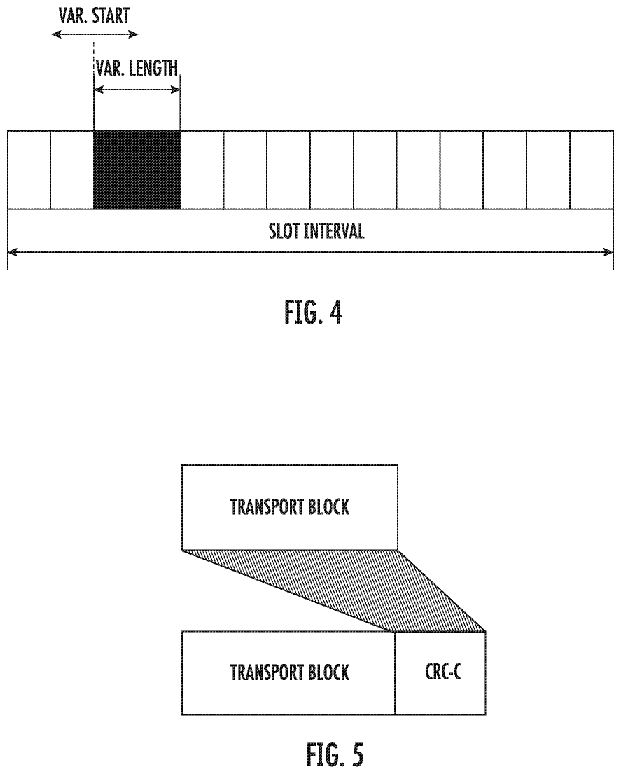

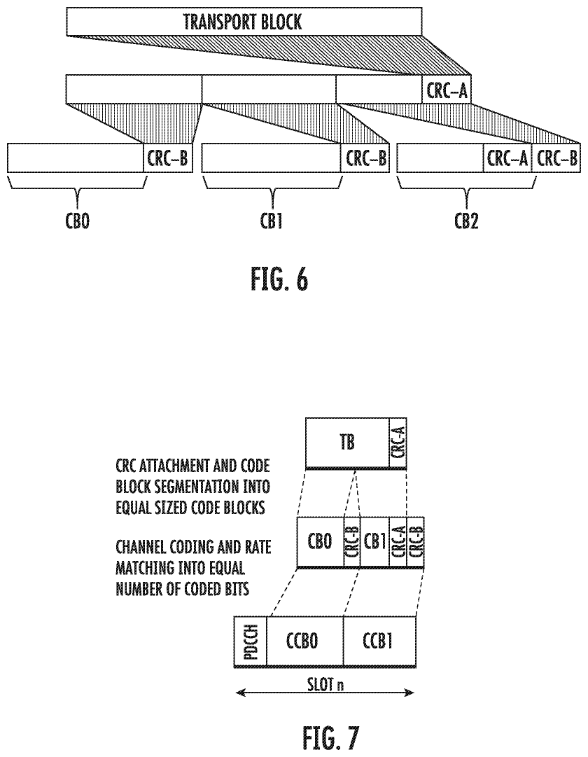

### DETAILED DESCRIPTION

Before describing in detail exemplary embodiments, it is noted that the embodiments reside primarily in combinations of apparatus components and processing steps related to using at least one of a single physical uplink shared channel or physical downlink shared channel (referred to herein collectively as PXSCH) for a single transport block (TB) transmission that exceeds a single slot. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

In this disclosure, the term “PXSCH” represents PDSCH or PUSCH. In some nonlimiting examples, one of PDSCH of PUSCH may be used for illustration or illumination of the teachings of the embodiments. It should be clear to one skilled in the art to practice the teachings to either of the PDSCH or PUSCH.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide for the use at least one of a single physical uplink shared channel or physical downlink shared channel (PXSCH) for a single transport block (TB) transmission that exceeds a single slot thereby providing a scheduling solution that can cope with the long processing delay, especially for high SCS.

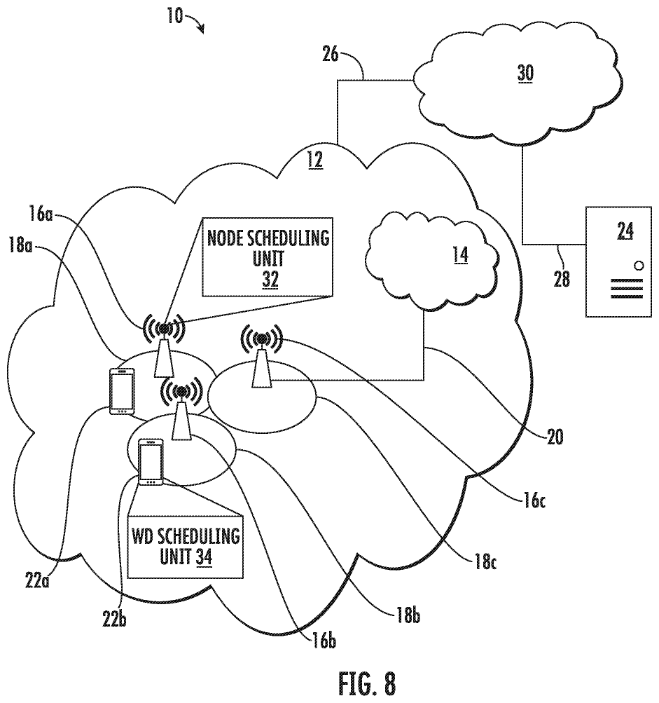

Referring again to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 8 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a node scheduling unit 32 which is configured to configure a transport block, TB, transmission that exceeds a single slot. A wireless device 22 is configured to include a WD scheduling unit 34 which is configured to configure a transport block, TB, transmission that exceeds a single slot.

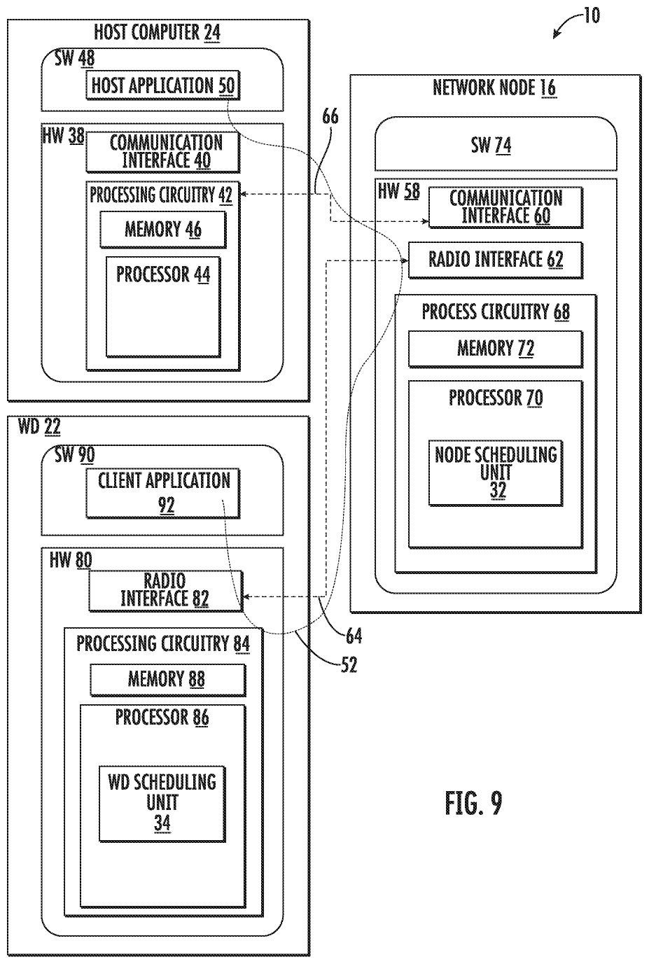

In some embodiments, the WD 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include node scheduling unit 32 configured to configure a transport block, TB, transmission that exceeds a single slot.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD scheduling unit 34 configured to configure a transport block, TB, transmission that exceeds a single slot.

In some embodiments, the inner workings of the network node 16, WD 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as node scheduling unit 32, and WD scheduling unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

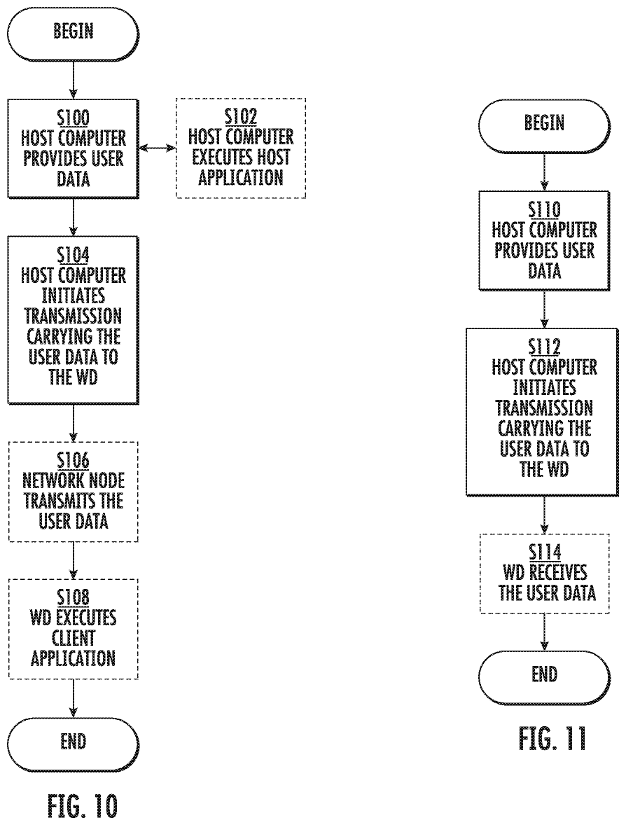

FIG. 10 is a flowchart illustrating an exemplary method implemented in a communication system, such as, for example, the communication system of FIGS. 8 and 9, in accordance with one embodiment. The communication system may include a host computer 24, a network node 16 and a WD 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 11 is a flowchart illustrating an exemplary method implemented in a communication system, such as, for example, the communication system of FIG. 8, in accordance with one embodiment. The communication system may include a host computer 24, a network node 16 and a WD 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

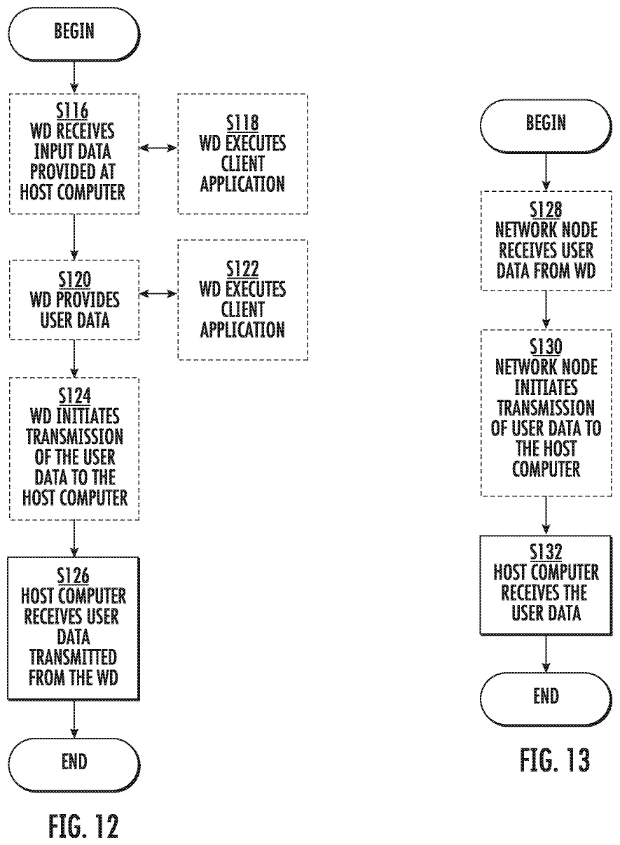

FIG. 12 is a flowchart illustrating an exemplary method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 13 is a flowchart illustrating an exemplary method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

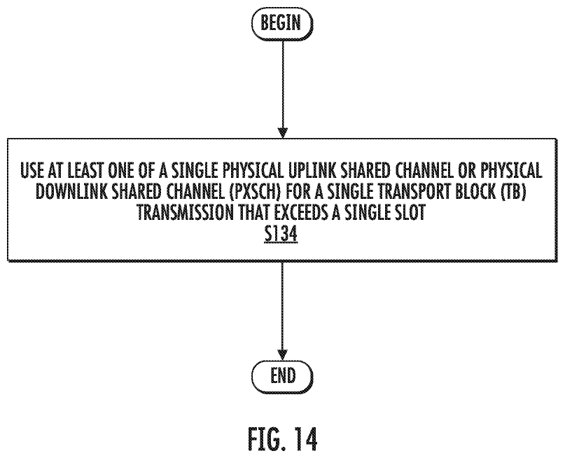

FIG. 14 is a flowchart of an exemplary process in a network node 16 for using at least one of a single physical uplink shared channel or physical downlink shared channel (PXSCH) for a single transport block (TB) transmission that exceeds a single slot. One or more Blocks and/or functions performed by network node 16 may be performed by one or more elements of network node 16 such as by node scheduling unit 32 in processing circuitry 68, processor 70, communication interface 60, radio interface 62, etc. In one or more embodiments, network node 16 such as via one or more of processing circuitry 68, processor 70, radio interface 62 and communication interface 60 is configured to use (Block S134) at least one of a single physical uplink shared channel or physical downlink shared channel (PXSCH) for a single transport block (TB) transmission that exceeds a single slot a single transport block for transmission over a time duration that exceeds a single time slot.

In one or more embodiments, the network node 16 is, such as via one or more of processing circuitry 68, processor 70, radio interface 62 and communication interface 60, configured to transmit a single TB over multiple PXSCHs with one PXSCH for each slot. In one or more embodiments, the network node 16 is, such as via one or more of processing circuitry 68, processor 70, radio interface 62 and communication interface 60, configured to indicate initial transmission of one or more code blocks (CBs) or code block groups (CBG) of a TB with a start length indicator (SLIV). In one or more embodiments, the network node 16 is, such as via one or more of processing circuitry 68, processor 70, radio interface 62 and communication interface 60, configured to group CBs transmitted in one or more PXSCHs into one or more CBG groups. In one or more embodiments, the network node 16 is, such as via one or more of processing circuitry 68, processor 70, radio interface 62 and communication interface 60, configured to use at least one of repetition, multi-PUSCH scheduling and single TB over multiple PUSCHs.

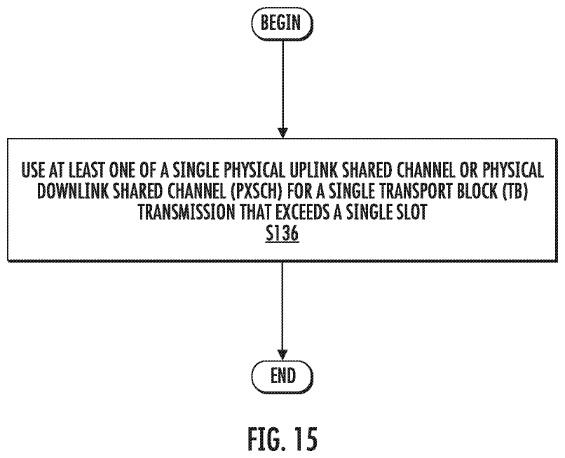

FIG. 15 is a flowchart of an exemplary process in a wireless device 22 according to some embodiments of the present disclosure for using at least one of a single physical uplink shared channel or physical downlink shared channel (PXSCH) for a single transport block (TB) transmission that exceeds a single slot. One or more Blocks and/or functions performed by wireless device 22 may be performed by one or more elements of wireless device 22 such as by WD scheduling unit 34 in processing circuitry 84, processor 86, radio interface 82, etc. In one or more embodiments, wireless device 22 such as via one or more of processing circuitry 84, processor 86 and radio interface 82 is configured to use (Block S136) at least one of a single physical uplink shared channel or physical downlink shared channel (PXSCH) for a single transport block (TB) transmission that exceeds a single slot.

In one or more embodiments, WD 22 such as via one or more of processing circuitry 84, processor 86 and radio interface 82 is configured to transmit a single TB over multiple PXSCHs with one PXSCH for each slot. In one or more embodiments, WD 22 such as via one or more of processing circuitry 84, processor 86 and radio interface 82 is configured to indicate initial transmission of one or more code blocks (CBs) or code block groups (CBG) of a TB with a start length indicator (SLIV). In one or more embodiments, WD 22 such as via one or more of processing circuitry 84, processor 86 and radio interface 82 is configured to group CBs transmitted in one or more PXSCHs into one or more CBG groups. In one or more embodiments, WD 22 such as via one or more of processing circuitry 84, processor 86 and radio interface 82 is configured to use at least one of repetition, multi-PUSCH scheduling and single TB over multiple PUSCHs.

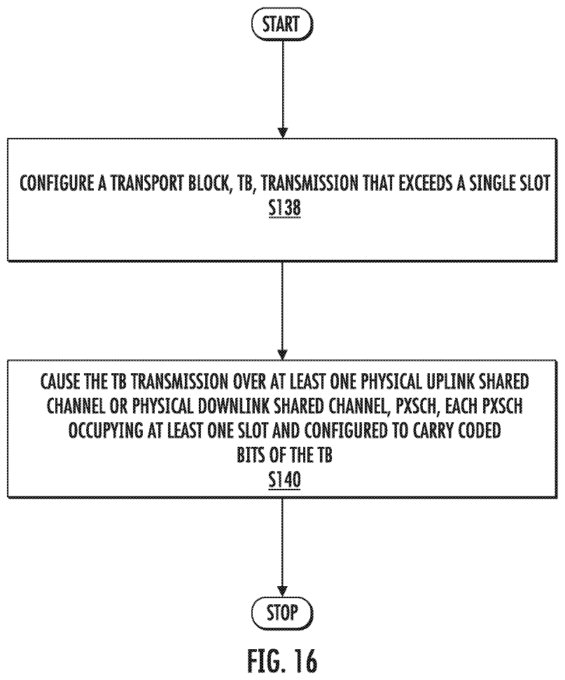

FIG. 16 is a flowchart of an example process in a network node configured to communicate with a WD. The network node 16 is, such as via one or more of processing circuitry 68, processor 70, radio interface 62 and communication interface 60, configured to configure a transport block, TB, transmission that exceeds a single slot (Block S138). In some embodiments, the process includes causing transmission of the TB over at least one physical uplink shared channel or physical downlink shared channel, PXSCH, each PXSCH occupying at least one slot and configured to carry coded bits of the TB (Block S140).

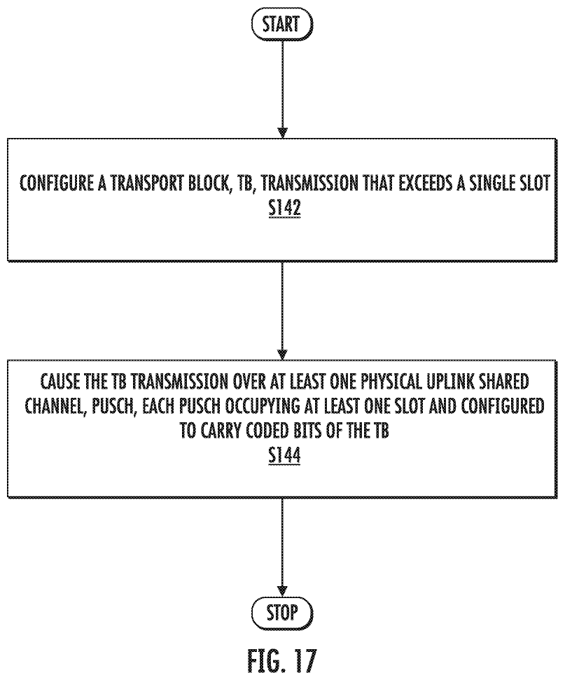

FIG. 17 is a flowchart of an example process in a WD configured to communicate with a network node. The WD 22 such as via one or more of processing circuitry 84, processor 86 and radio interface 82 is configured to configure a transport block, TB, transmission that exceeds a single slot (Block S142). The process also includes causing transmission of the TB over at least one physical uplink shared channel, PUSCH, each PUSCH occupying at least one slot and configured to carry coded bits of the TB (Block S144).

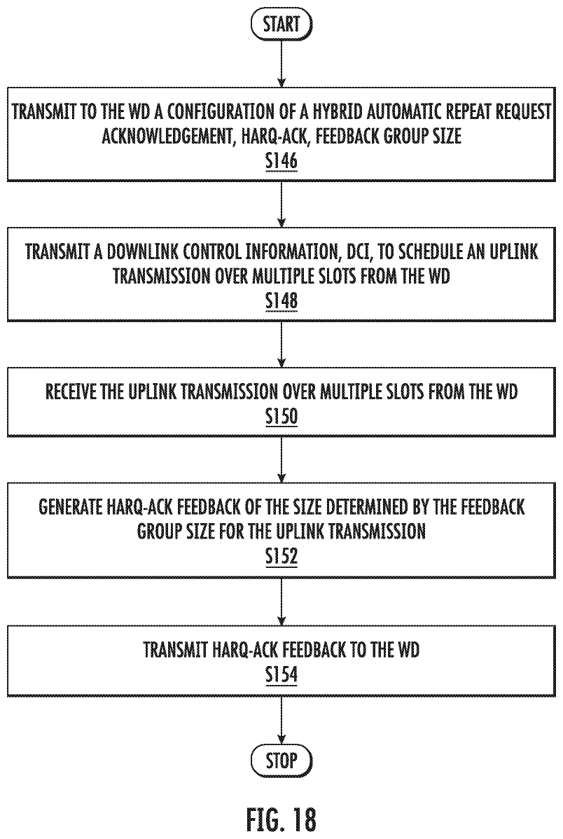

FIG. 18 is a flowchart of another example process in a network node configured to communicate with a WD. The network node 16 is, such as via one or more of processing circuitry 68, processor 70, radio interface 62 and communication interface 60, configured to transmit to the WD a configuration of a hybrid automatic repeat request acknowledgement, HARQ-ACK, feedback group size (Block S146). The process also includes transmitting a downlink control information, DCI, to schedule an uplink transmission over multiple slots from the WD (Block S148). The process further includes receiving the uplink transmission over multiple slots from the WD (Block S150). The process also includes generating HARQ-ACK feedback of the size determined by the feedback group size for the uplink transmission (Block S152). The process further includes transmitting the HARQ-ACK feedback to the WD (Block S154).

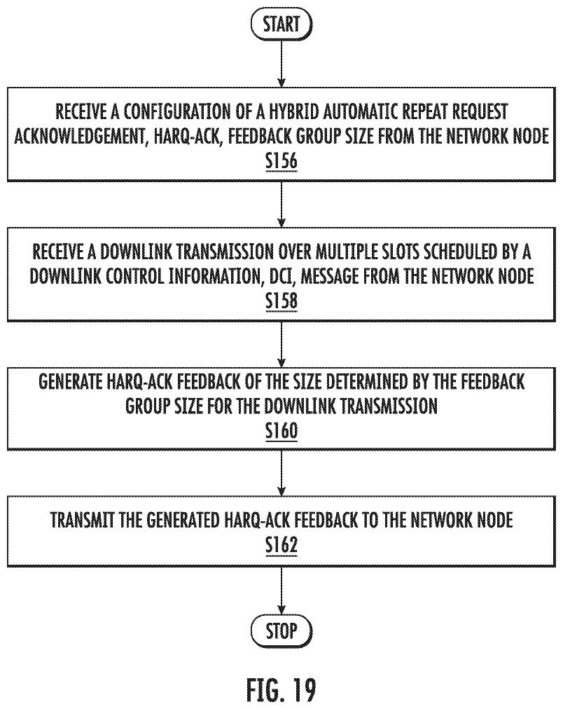

FIG. 19 is a flowchart of another example process in a WD configured to communicate with a network node. The WD 22 such as via one or more of processing circuitry 84, processor 86 and radio interface 82 is configured to receive a configuration of a hybrid automatic repeat request acknowledgement, HARQ-ACK, feedback group size from the network node (Block S156). The process also includes receiving a downlink transmission over multiple slots scheduled by a downlink control information, DCI, message from the network node (Block S158). The process further includes generating HARQ-ACK feedback of the size determined by the feedback group size for the downlink transmission (Block S160). The process also includes transmitting the generated HARQ-ACK feedback to the network node (Block S162).

Embodiments herein provide for the use and/or generation and/or configuration (for the sake of simplicity, the single term “use” as used herein may be defined as use and/or generation and/or configuration) of at least one of a single physical uplink shared channel or physical downlink shared channel (PXSCH) for a single transport block (TB) transmission that exceeds a single slot.

Having described the general process flow of arrangements of the disclosure and having provided examples of hardware and software arrangements for implementing the processes and functions of the disclosure, the sections below provide details and examples of arrangements for use and/or generation and/or configuration of at least one of a single physical uplink shared channel or physical downlink shared channel (PXSCH) for a single transport block (TB) transmission that exceeds a single slot, which may be implemented by the network node 16 and/or wireless device 22. It is noted that, for the sake of brevity, the single term “use” as used herein may be defined as use and/or generation and/or configuration) with respect to, for example, the use of at least one of a single physical uplink shared channel or physical downlink shared channel (PXSCH) for a single transport block (TB) transmission that exceeds a single slot.

It is also noted that the term “use” may refer to transmitting or receiving on a PUSCH or a PDSCH. For example, a network node 16 may use the PDSCH for transmitting and use the PUSCH for receiving. Conversely, a WD 22 may use the PUSCH for transmitting and use the PDSCH for receiving.

### Scheduling Embodiments

### Transport Block Transmission Over Multiple Slots

Various embodiments are directed toward a single TB carried by a single PXSCH over more than one slot. According to these embodiments, a TB may be initially transmitted by network node 16 or WD 22 over a single PUSCH/PDSCH of duration longer than 14 symbols.

### Embodiment 1: Single TB Carried by a Single PXSCH Over More than One Slot

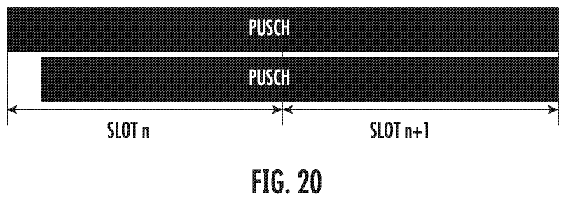

FIG. 20 shows an example of the PUSCH crossing a slot boundary (first PUSCH of 28 symbols, and second of 26 symbols). Reference is made to the part of the PXSCH that is within a certain slot until slot boundary as a PXSCH segment. For example, in FIG. 20, the first PUSCH has 2 PUSCH segments, each of 14 symbols. Each segment carries a part of the coded bits for the same TB. Accordingly, the current NR specifications may be extended to support further SLIV values that support S and L combinations that yield PXSCH lengths longer than 14 symbols.

As a non-limiting example, SLIV supports all or a subset of combinations of S={0 . . . 13}, and L {1, 2 . . . , Lmax}, where Lmax may be predefined or higher layer configured. One nonlimiting exemplary embodiment determines Lmax as 14*B, where B is a slot aggregation factor configured by higher layer signalling.

In another nonlimiting exemplary embodiment, the allocated time domain resource is signalled via three fields: S for the start OFDM symbols in the first slot, A for the number of fully allocated slots following the first slot, and L for the number of allocated OFDM symbols in the last scheduled slot. The WD 22 can determine that the total number of scheduled OFDM symbols are S+14*A+L.

As another non-limiting exemplary embodiment, SLIV supports all or a subset of combinations of S={0 . . . 13}, and L includes all values integer numbers from {1, . . . , 14}, and additionally multiples of 14 symbols, i.e. {1, . . . , 14, 28, 56, . . . , Lmax}. In other words, L may be in the union of {1, 2 . . . 14} and {28, 56, 112 . . . Lmax}.

As a variant of these embodiments, the PXSCH may end at a slot boundary for all L>14. Thereby, the signalling of scheduled time domain resources reduces to S for the starting OFDM symbol in the first slot and A for the total number of occupied slots. The WD 22 may then determine the total number of scheduled OFDM symbols are 14*A−S.

The demodulation reference signal (DMRS) transmission for a PXSCH spanning over more than one slot may be implemented in various embodiments. In the following description, WD 22 may determine the existing Release-16 DMRS patterns based on existing Release-16 higher layer configuration of DRMS patterns.

In an embodiment, Each PXSCH segment within a slot follows the existing Release-16 DMRS patterns of the same duration within the slot.

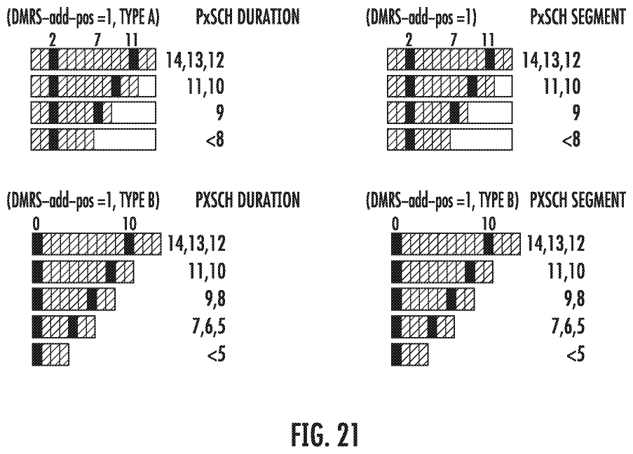

The 3GPP Release-16 patterns for PXSCH of length <=14 are applicable to PXSCH segments of L<=14. Each of the PXSCH segments follows the DMRS pattern from Release-16 that corresponds to the same PXSCH length as shown in the example of FIG. 21 which illustrates example mappings of DMRS patterns for PXSCH segments.

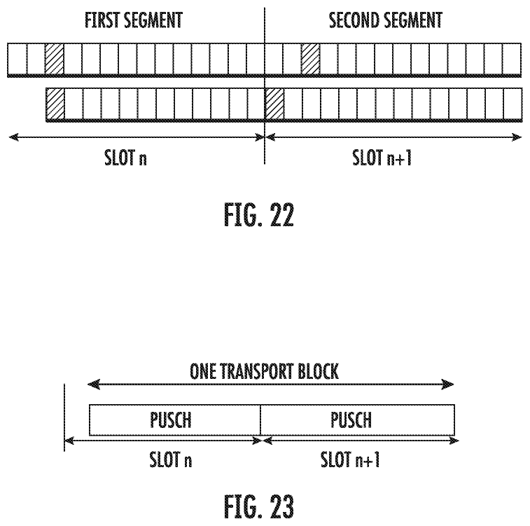

For the first PUSCH in FIG. 21, the DMRS positions in each PUSCH segment are delineated. Type A mapping is used. For the second PUSCH in FIG. 21, the DMRS positions are according to Type B mapping. The DMRS(s) are located at the first symbol of each PUSCH segment FIG. 22 illustrates an example DMRS pattern for PUSCH length >14.

In other embodiments, the first X segment(s) of the PXSCH follows Release-16 patterns, while the remaining segments follow a predefined or fixed pattern.

In one nonlimiting exemplary embodiment, the first PXSCH segment in the first slot follows the existing 3GPP Release-16 DMRS patterns of the same duration within the slot. The rest of the remaining PXSCH segments may follow a different DMRS pattern. One example is a single DMRS at the beginning of the segment. Another example is that no DMRS is present for the remaining PXSCH segments.

### Embodiment 2: Single TB Over Multiple PXSCH with One PXSCH for Each Slot

In this embodiment, a single TB is transmitted over multiple PXSCH with one PXSCH for each slot. A TB can be initially transmitted by network node 16 or WD 22 over multiple PXSCHs, each PXSCH can be up to 14 symbols within a slot. Each PXSCH carries part of the coded bits of the same transport block. The initial transmission of a transport block can be scheduled using a single or multiple DCIs as shown in FIG. 23.

In cases of multiple DCIs, each DCI may indicate scheduling information for part of the TB. In cases of a single DCI scheduling multiple PXSCH(s), WD 22 may be indicated with RRC/or dynamically via DCI to perform one the following possible transmission modes:

Case 1: Single TB spans over the multiple scheduled PUSCHs; and

Case 2: scheduling may be done according to the 3GPP Release-16 behavior (for example as described in model, 2 and 3 in Section 2.1.4 of the 3GPP NR standards).

In cases of radio resource control (RRC) configuration, a new RRC parameter may be introduced that may indicate a common setting (case 1 or 2) may be applicable to all the configured time resource allocations in the PXSCH TDRA allocations.

Alternatively, one non-limiting example is to add a column in the PUSCH/PDSCH allocation table that indicates either operating as described in case 1 or case 2 for each of the rows in the table. Similarly, a multi-PDSCH allocation table may be introduced.

### Embodiment 2a: WD 22 is Configured with Both Repetitions and Single TB Over Multiple PUSCHs

In this embodiment, WD 22 may be configured with both repetitions and single TB over multiple PUSCHs. Table 6 below shows an example where WD 22 is configured with both repetitions and single TB over multiple PUSCHs. A new column, referred to as “single TB”, indicates at least 2 states. State 1 is represented in the table below as “0” and indicates that the WD 22 should send one TB spanning the indicated time resources (by K2, S, L, and a repetition factor). State 2 is represented in the table below as “1” and indicates operation according to 3GPP Release-16 repetition behavior.

TABLE 6

| | PUSCH | | | | |
|---|---|---|---|---|---|
| Row | mapping | | | Number of | Single |
| index | type | K₂ | SLIV | Repetitions | TB |
| I | {Type A, | {0 . . . 32} | {0 . . . 127} | {n1, n2, n3, | {0, 1} |
| | Type B} | | | n4, n7, n8, | |
| | | | | n12, n16} | |

As an extension of these embodiments, in the case where the network node 16 indicates a single TB over multiple PUSCHs, the indicated SLIV may be interpreted as:
S: starting symbol of the first scheduled PUSCH;
L: ending symbol of the last scheduled PUSCH; and
PUSCHs in between occupy the full slot.

### Embodiment 2b: WD 22 is Configured with Both 3GPP Rel-16 Multi-PUSCH Scheduling and Single TB Over Multiple PUSCHs

In this embodiment, the WD 22 may be configured with both 3GPP Release-16 multi-PUSCH scheduling and single TB transmission over multiple PUSCHs. Table 7 below shows an example where the WD 22 is configured with both Release-16 multi-PUSCH scheduling and single TB transmission over multiple PUSCHs.

A new column, referred to as “single TB”, indicates if the WD 22 should send one TB spanning the indicated Time resources (by K2,SLIVs), or a separate TB is carried in each one of the scheduled PUSCHs.

TABLE 7

| Row | | PUSCH mapping type | SLIV{PUSCH1 . . . | Single |
|---|---|---|---|---|
| index | K2 | {PUSCH1 . . . PUSCH8} | PUSCH8} | TB |
| 1 | {0 . . . 32} | For each scheduled | For each scheduled PUSCH, | {0, 1} |
| | | PUSCH, a PUSCH | a SLIV value between | |
| | | mapping type {A or B} | {0, . . . 127} | |
| | | is indicated | is indicated | |

### Embodiment 2c: The WD 22 is Configured with Repetition, Multi-PUSCH Scheduling and Single TB Over Multiple PUSCHs

In this embodiment, WD 22 may be configured with repetition, multi-PUSCH scheduling and single TB over multiple PUSCHs.

If the WD 22 supports configuration of both repetition and multi-PUSCH scheduling at the same time, then at least one row in the TDRA table can indicate that the repetition factor may be greater than 1, and multiple valid non-empty SLIV values.

If the WD 22 is indicated to send single TB over multiple PUSCH, repetition factor >1, and multiple valid SLIVs, one of the following alternatives may be applied.
The WD 22 may send a single TB spanning the indicated time resources which would have been assigned for repetitions if the single TB over multiple PUSCH was not indicated; and/or
The WD 22 may send a single TB indicated by the different SLIVs.

In any of the above embodiments, the new signaling field “single TB” may be replaced with a “single or multiple HARQ processes” field. This field allows signaling of two possible transmission modes: (1) the transmitted bits belong to a single HARQ process; or (2) the transmitted bits belongs to multiple HARQ processes with one HARQ process for each scheduled slot.

### HARQ-ACK Embodiments

### Embodiment 3: Operation when Code Block Group (CBG) Based Feedback is Configured

In these embodiments, CBG based feedback may be configured. According to these embodiments, a DCI scheduling a single PXSCH can indicate initial transmission of one or more CB (or CBG) of a certain TB. Thus, the initial transmission scheduled by a DCI does not necessarily indicate transmission of the full TB.

When multiple PXSCH are scheduled using the same DCI and carry a single TB, the DCI can indicate initial or retransmission of one or more CB (or CBG) of a certain TB. If the WD 22 is configured with CBG retransmission, the WD 22 may provide a HARQ-feedback per CBG. In the case of single TB over multiple slots, the CBs of the TB are grouped into CBGs following the procedures described in the section below.

Under the restriction that no CB crosses a slot boundary, one or more alternatives can be considered for CBG grouping.

In some embodiments, when scheduling one TB across multiple PUSCHs, the CBs in each PXSCH may be grouped into one CBG. Since the PXSCH scheduled using a single DCI can be of different length, the number of CBs per CBG is not necessarily the same for all the scheduled PXSCHs.

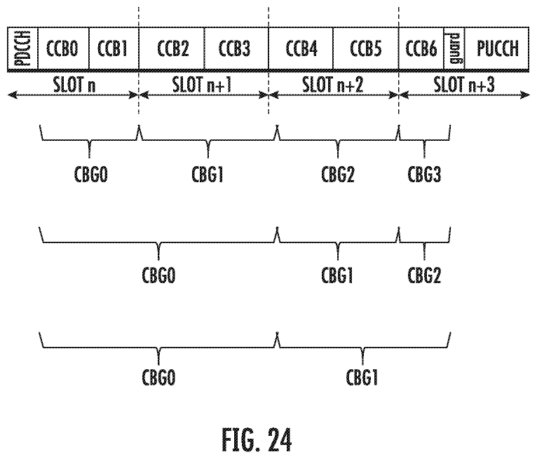

In some embodiments, the CB(s) transmitted in one or more PXSCHs may be grouped into one CBG group as shown in FIG. 24. As a non-limiting example, the CBGs may be constructed as follows:
The maximum number N of CBG(s) per TB is configured by RRC signaling;
The number M of CBG(s) in the TB equals to min(C, N), where C is the number of scheduled slots;
For CBG construction:
   The first Mod(C,M) CBG(s) out of total M CBG(s) include ceil(C/M) slots per CBG;
   The remaining M-Mod(C,M) CBG(s) include floor(C/M) slots per CBG.
      In other embodiments, the CB(s) transmitted in one PXSCH are grouped into one or more CBG group.

As a non-limiting example, the CBGs may be constructed as follows.
The maximum number N of CBG(s) per TB is configured by RRC signaling:
   If the number of scheduled slots, denoted by S, is greater than or equal to the configured maximum number of CBGs, the number M of CBG(s) in the TB equals to N.
      The first Mod(S,M) CBG(s) out of total M CBG(s) include ceil(S/M) slots per CBG;
      The remaining M-Mod(S,M) CBG(s) include floor(S/M) slots per CBG.
   Else
      If the number of coded blocks, denoted by C, is less than or equal to the configured maximum number of CBGs, the number M of CBG(s) in the TB equals to C (one CB per CBG).
      Else the number M of CBG(s) in the TB equals to N.
         The first N−S with more than one CB out of total S slots include more than one CBG.

According to one aspect, a network node 16 configured to communicate with a wireless device (WD). The network node 16 includes processing circuitry 68 configured to: configure a transport block, TB, transmission that exceeds a single slot; and cause the TB transmission over at least one physical uplink shared channel, or physical downlink shared channel, PXSCH, each PXSCH, occupying at least one slot and configured to carry coded bits of the TB.

According to this aspect, in some embodiments, the processing circuitry 68 is further configured to cause transmission of a single TB over multiple PXSCHs with one PXSCH for each slot of a succession of slots. In some embodiments, the processing circuitry 68 is further configured to support an extended set of start, S, and length, L, indicators to yield a PXSCH length longer than fourteen symbols. In some embodiments, S={0, 1, 2 . . . 13} and L={1, 2 . . . Lₘₐₓ} where Lₘₐₓ is predefined or configured by higher layer signaling. In some embodiments, Lₘₐₓ is fourteen times a slot aggregation factor, the slot aggregation factor being configured by higher layer signaling to the WD. In some embodiments, L is in the union of {1, 2 . . . 14} and {28, 56, 112 . . . Lₘₐₓ}. In some embodiments, the extended set further includes a number A indicating a number of fully allocated slots following the first slot, such that a total number of scheduled orthogonal frequency division multiplexed, OFDM, symbols is determinable by the WD as S+14*A+L. In some embodiments, each PXSCH segment within a slot of a succession of slots has a demodulation reference signal, DMRS, pattern. In some embodiments, each of a first number of PXSCH segments of a PXSCH have a first demodulation reference signal, DMRS, pattern, and subsequent PXSCH segments of the PXSCH have one or more predefined DMRS patterns. In some embodiments, the TB is transmitted over multiple PXSCH with one PXSCH per slot of a succession of slots, each PXSCH carrying a portion of coded bits of the TB. In some embodiments, the processing circuitry 68 is further configured to indicate initial transmission of one or more code blocks, CBs, or code block groups, CBG, of a TB with a start length indicator, SLIV. In some embodiments, the processing circuitry is further configured with repetitions and a single TB over multiple physical uplink shared channels, PUSCH. In some embodiments, the processing circuitry is further configured to configure the WD with Third Generation Partnership Project, 3GPP, Release 16-compatible multiple physical uplink shared channel, PUSCH, scheduling and with a single TB over multiple PUSCHs.

According to another aspect, a method in a network node 16 configured to communicate with a wireless device, WD 22, is provided. The method includes configuring, via the processing circuitry 68 a transport block, TB, transmission that exceeds a single slot; and causing the TB transmission over at least one physical uplink shared channel or physical downlink shared channel, PXSCH, each PXSCH occupying at least one slot and configured to carry coded bits of the TB.

According to this aspect, in some embodiments, the method further includes causing transmission of a single TB over multiple PXSCHs with one PXSCH for each slot of a succession of slots. In some embodiments, the method also includes supporting an extended set of start, S, and length, L, indicators to yield a PXSCH length longer than fourteen symbols. In some embodiments, S={0, 1, 2 . . . 13} and L={1, 2 . . . Lₘₐₓ} where Lₘₐₓ is predefined or configured by higher layer signaling. In some embodiments, Lₘₐₓ is fourteen times a slot aggregation factor, the slot aggregation factor being configured by higher layer signaling to the WD 22. In some embodiments, L is in the union of {1, 2 . . . 14} and {28, 56, 112 . . . Lₘₐₓ}. In some embodiments, the extended set further includes a number A indicating a number of fully allocated slots following the first slot, such that a total number of scheduled orthogonal frequency division multiplexed, OFDM, symbols is determinable by the WD as S+14*A+L. In some embodiments, each PXSCH segment within a slot of a succession of slots has a demodulation reference signal, DMRS, pattern. In some embodiments, each of a first number of PXSCH segments of a PXSCH have a first demodulation reference signal, DMRS, pattern, and subsequent PXSCH segments of the PXSCH have one or more predefined DMRS patterns. In some embodiments, the TB is transmitted over multiple PXSCH with one PXSCH per slot of a succession of slots, each PXSCH carrying a portion of coded bits of the TB. In some embodiments, the method further includes indicating initial transmission of one or more code blocks, CBs, or code block groups, CBG, of a TB with a start length indicator, SLIV. In some embodiments, the method further includes configuring the WD with repetitions and a single TB over multiple physical uplink shared channels, PUSCH. In some embodiments, the method also includes configuring the WD with Third Generation Partnership Project, 3GPP, Release 16-compatible multiple physical uplink shared channel, PUSCH, scheduling and with a single TB over multiple PUSCHs.

According to another aspect, a WD 22 configured to communicate with a network node 16 is provided. The WD 22 includes processing circuitry 84 configured to: configure a transport block, TB, transmission that exceeds a single slot; and cause the TB transmission over at least one physical uplink shared channel, PUSCH, each PUSCH occupying at least one slot and configured to carry coded bits of the TB.

According to this aspect, in some embodiments, the processing circuitry 84 is further configured to cause transmission of a single TB over multiple PUSCHs with one PUSCH for each slot of a succession of slots. In some embodiments, the processing circuitry 84 is further configured to support an extended set of start, S, and length, L, indicators to yield a PUSCH length longer than 14 symbols. In some embodiments, S={0, 1, 2 . . . 13} and L={1, 2 . . . Lₘₐₓ} where Lₘₐₓ is predefined or configured by higher layer signaling. In some embodiments, the TB is transmitted over multiple PUSCH with one PUSCH per slot of a succession of slots, each PUSCH carrying a portion of coded bits of the TB.

According to yet another aspect, a method in a wireless device, WD 22, configured to communicate with a network node 16 is provided. The method includes configuring, via the processing circuitry 84, a transport block, TB, transmission that exceeds a single slot; and causing the TB transmission over at least one physical uplink shared channel, PUSCH, each PUSCH occupying at least one slot and configured to carry coded bits of the TB.

According to this aspect, in some embodiments, the method also includes causing transmission of a single TB over multiple PUSCHs with one PUSCH for each slot of a succession of slots. In some embodiments, the method also includes supporting an extended set of start, S, and length, L, indicators to yield a PUSCH length longer than 14 symbols. In some embodiments, S={0, 1, 2 . . . 13} and L={1, 2 . . . Lₘₐₓ} where Lₘₐₓ is predefined or configured by higher layer signaling. In some embodiments, the TB is transmitted over multiple PUSCH with one PUSCH per slot of a succession of slots, each PUSCH carrying a portion of coded bits of the TB.

According to another aspect, a WD 22 configured to communicate with a network node 16 is provided. The WD 22 includes a radio interface 82 configured to: receive a configuration of a hybrid automatic repeat request acknowledgement, HARQ-ACK, feedback group size from the network node 16; and receive a downlink transmission over multiple slots scheduled by a downlink control information, DCI, message from the network node 16. The WD 22 also includes processing circuitry 84 configured to generate HARQ-ACK feedback of the size determined by the feedback group size for the downlink transmission. The radio interface 82 is further configured to transmit the generated HARQ-ACK feedback to the network node 16.

In some embodiments, the HARQ-ACK feedback is provided per code block group, CBG, when the WD 22 is configured with CBG retransmission. In some embodiments, code blocks, CB, of a single transport block, TB, are grouped into code block groups, CBGs. In some embodiments, the processing circuitry 84 is further configured to schedule a single transport block, TB across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

According to yet another aspect, a method in a wireless device, WD 22, configured to communicate with a network node 16 is provided. The method includes receiving a configuration of a hybrid automatic repeat request acknowledgement, HARQ-ACK, feedback group size from the network node 16. The method also includes receiving a downlink transmission over multiple slots scheduled by a downlink control information, DCI, message from the network node 16, generating HARQ-ACK feedback of the size determined by the feedback group size for the downlink transmission, and transmitting the generated HARQ-ACK feedback to the network node 16.

According to this aspect, in some embodiments, the HARQ-ACK feedback is provided per code block group, CBG, when the WD 22 is configured with CBG retransmission. In some embodiments, code blocks, CB, of a single transport block, TB, are grouped into code block groups, CBGs. In some embodiments, the method also includes scheduling a single transport block, TB across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

According to another aspect, a network node 16 in communication with a wireless device, WD 22, is provided. The network node 16 includes a radio interface 62 configured to: transmit to the WD 22 a configuration of a hybrid automatic repeat request acknowledgement, HARQ-ACK, feedback group size; transmit a downlink control information, DCI, to schedule an uplink transmission over multiple slots from the WD 22; and receive the uplink transmission over multiple slots from the WD 22. The network node 16 also includes processing circuitry 68 configured to generate HARQ-ACK feedback of the size determined by the feedback group size for the uplink transmission, the radio interface further configured to transmit the HARQ-ACK feedback to the WD 22.

According to this aspect, in some embodiments, the HARQ-ACK feedback is provided per code block group, CBG, when the WD 22 is configured with CBG retransmission. In some embodiments, code blocks, CB, of a single transport block, TB, are grouped into code block groups, CBGs. In some embodiments, the processing circuitry 68 is further configured to schedule a single transport block, TB, across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

According to yet another aspect, a method in a network node 16 in communication with a wireless device, WD 22, is provided. The method includes transmitting to the WD 22 a configuration of a hybrid automatic repeat request acknowledgement, HARQ-ACK, feedback group size. The method also includes transmitting a downlink control information, DCI, to schedule an uplink transmission over multiple slots from the WD 22, receiving the uplink transmission over multiple slots from the WD 22, generating HARQ-ACK feedback of the size determined by the feedback group size for the uplink transmission and transmitting the HARQ-ACK feedback to the WD 22.

According to this aspect, in some embodiments, the HARQ-ACK feedback is provided per code block group, CBG, when the WD 22 is configured with CBG retransmission. In some embodiments, code blocks, CB, of a single transport block, TB, are grouped into code block groups, CBGs. In some embodiments, the method also includes scheduling a single transport block, TB, across multiple physical uplink shared channels, PUSCHs, each of the multiple PUSCHs having code blocks, CBs, grouped into a single code block groups, CBG. In some embodiments, code blocks, CBs, transmitted in one or more PUSCHs are grouped into a single code block group, CBG.

Some Embodiments are as Follows:

Embodiment A1. A network node configured to communicate with a wireless device (WD), the network node configured to, and/or comprising a radio interface and/or comprising processing circuitry configured to:

use at least one of a single physical uplink shared channel or physical downlink shared channel (PXSCH) for a single transport block (TB) transmission that exceeds a single slot.

Embodiment A2. The network node of Embodiment A1, wherein the network node, and/or the radio interface and/or the processing circuitry is further configured to transmit a single TB over multiple PXSCHs with one PXSCH for each slot.

Embodiment A3. The network node of any one of Embodiments A1 and A2, wherein the network node, and/or the radio interface and/or the processing circuitry is further configured to indicate initial transmission of one or more code blocks (CBs) or code block groups (CBG) of a TB with a start length indicator (SLIV).

Embodiment A4. The network node of any one of Embodiments A1-A3, wherein the network node, and/or the radio interface and/or the processing circuitry is further configured to group CBs transmitted in one or more PXSCHs into one or more CBG groups.

Embodiment A5. The network node of any one of Embodiments A1-A4, wherein the network node, and/or the radio interface and/or the processing circuitry is further configured to use at least one of repetition, multi-PUSCH scheduling and single TB over multiple PUSCHs.

Embodiment B1. A method implemented in a network node, the method comprising:

using at least one of a single physical uplink shared channel or physical downlink shared channel (PXSCH) for a single transport block (TB) transmission that exceeds a single slot.

Embodiment B2. The method of Embodiment B1 further comprising transmitting a single TB over multiple PXSCHs with one PXSCH for each slot.

Embodiment B3. The method of any one of Embodiments B1 and B2 further comprising indicating initial transmission of one or more code blocks (CBs) or code block groups (CBG) of a TB with a start length indicator (SLIV).

Embodiment B4. The method of any one of Embodiments B1-B3, further comprising grouping CBs transmitted in one or more PXSCHs into one or more CBG groups.

Embodiment B5. The method of any one of Embodiments B1-B4 further comprising using at least one of repetition, multi-PUSCH scheduling and single TB over multiple PUSCHs.

Embodiment C1. A wireless device (WD) configured to communicate with a network node, the WD configured to, and/or comprising a radio interface and/or processing circuitry configured to:

use at least one of a single physical uplink shared channel or physical downlink shared channel (PXSCH) for a single transport block (TB) transmission that exceeds a single slot.

Embodiment C2. The WD of Embodiment C1, wherein the WD, and/or the radio interface and/or the processing circuitry is further configured to transmit a single TB over multiple PXSCHs with one PXSCH for each slot.

Embodiment C3. The WD of any one of Embodiments C1 and C2, wherein the WD, and/or the radio interface and/or the processing circuitry is further configured to indicate initial transmission of one or more code blocks (CBs) or code block groups (CBG) of a TB with a start length indicator (SLIV).

Embodiment C4. The WD of one of Embodiments C1-C3, wherein the WD, and/or the radio interface and/or the processing circuitry is further configured to group CBs transmitted in one or more PXSCHs into one or more CBG groups.

Embodiment C5. The WD of any one of Embodiments C1-C4, wherein the WD, and/or the radio interface and/or the processing circuitry is further configured to use at least one of repetition, multi-PUSCH scheduling and single TB over multiple PUSCHs.

Embodiment D1. A method implemented in a wireless device (WD), the method comprising:

using at least one of a single physical uplink shared channel or physical downlink shared channel (PXSCH) for a single transport block (TB) transmission that exceeds a single slot.

Embodiment D2. The method of Embodiment D1 further comprising to transmitting a single TB over multiple PXSCHs with one PXSCH for each slot.

Embodiment D3. The method of any one of Embodiments D1 and D2 further comprising indicating initial transmission of one or more code blocks (CBs) or code block groups (CBG) of a TB with a start length indicator (SLIV).

Embodiment D4. The method of one of Embodiments D1-D3 further comprising grouping CBs transmitted in one or more PXSCHs into one or more CBG groups.

Embodiment D5. The method of any one of Embodiments D1-D4 further comprising using at least one of repetition, multi-PUSCH scheduling and single TB over multiple PUSCHs.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-36. (canceled)

37. A wireless device, WD, configured to communicate with a network node, the WD comprising:
a radio interface configured to:
receive a configuration of a hybrid automatic repeat request acknowledgement, HARQ-ACK, feedback group size from the network node; and
receive a downlink transmission over multiple slots scheduled by a downlink control information, DCI, message from the network node; and
processing circuitry configured to generate HARQ-ACK feedback of the size determined by the feedback group size for the downlink transmission, the radio interface being further configured to transmit the generated HARQ-ACK feedback to the network node.

38. The WD of claim 37, wherein the HARQ-ACK feedback is provided per code block group, CBG, when the WD is configured with CBG retransmission.

39. The WD of claim 37, wherein code blocks, CB, of a single transport block, TB, are grouped into code block groups, CBGs.

40. The WD of claim 37, wherein the processing circuitry is further configured to schedule a single transport block, TB across multiple physical uplink shared channels, PUSCHs, each of the multiple PUSCHs having code blocks, CBs, grouped into a single code block groups, CBG.

41. The WD of claim 37, wherein code blocks, CBs, transmitted in one or more PUSCHs are grouped into a single code block group, CBG.

42. A method in a wireless device, WD, configured to communicate with a network node, the method comprising:
receiving a configuration of a hybrid automatic repeat request acknowledgement, HARQ-ACK, feedback group size from the network node;
receiving a downlink transmission over multiple slots scheduled by a downlink control information, DCI, message from the network node;
generating HARQ-ACK feedback of the size determined by the feedback group size for the downlink transmission; and
transmitting the generated HARQ-ACK feedback to the network node.

43. The method of claim 42, wherein the HARQ-ACK feedback is provided per code block group, CBG, when the WD is configured with CBG retransmission.

44. The method of claim 42, wherein code blocks, CB, of a single transport block, TB, are grouped into code block groups, CBGs.

45. The method of claim 42, further comprising scheduling a single transport block, TB across multiple physical uplink shared channels, PUSCHs, each of the multiple PUSCHs having code blocks, CBs, grouped into a single code block groups, CBG.

46. The method of claim 42, wherein code blocks, CBs, transmitted in one or more PUSCHs are grouped into a single code block group, CBG.

47. A network node in communication with a wireless device, WD, the network node comprising:
a radio interface configured to:
transmit to the WD a configuration of a hybrid automatic repeat request acknowledgement, HARQ-ACK, feedback group size;
transmit a downlink control information, DCI, to schedule an uplink transmission over multiple slots from the WD; and
receive the uplink transmission over multiple slots from the WD;
processing circuitry configured to generate HARQ-ACK feedback of the size determined by the feedback group size for the uplink transmission, the radio interface further configured to transmit the HARQ-ACK feedback to the WD.

48. The network node of claim 47, wherein the HARQ-ACK feedback is provided per code block group, CBG, when the WD is configured with CBG retransmission.

49. The network node of claim 47, wherein code blocks, CB, of a single transport block, TB, are grouped into code block groups, CBGs.

50. The network node of claim 47, wherein the processing circuitry is further configured to schedule a single transport block, TB, across multiple physical uplink shared channels, PUSCHs, each of the multiple PUSCHs having code blocks, CBs, grouped into a single code block groups, CBG.

51. The network node of claim 47, wherein code blocks, CBs, transmitted in one or more PUSCHs are grouped into a single code block group, CBG.

52. A method in a network node in communication with a wireless device, WD, the method comprising:
transmitting to the WD a configuration of a hybrid automatic repeat request acknowledgement, HARQ-ACK, feedback group size;
transmitting a downlink control information, DCI, to schedule an uplink transmission over multiple slots from the WD;
receiving the uplink transmission over multiple slots from the WD;
generating HARQ-ACK feedback of the size determined by the feedback group size for the uplink transmission; and
transmitting the HARQ-ACK feedback to the WD.

53. The method of claim 52, wherein the HARQ-ACK feedback is provided per code block group, CBG, when the WD is configured with CBG retransmission.

54. The method of claim 52, wherein code blocks, CB, of a single transport block, TB, are grouped into code block groups, CBGs.

55. The method of claim 52, further comprising scheduling a single transport block, TB, across multiple physical uplink shared channels, PUSCHs, each of the multiple PUSCHs having code blocks, CBs, grouped into a single code block groups, CBG.

56. The method of claim 52, wherein code blocks, CBs, transmitted in one or more PUSCHs are grouped into a single code block group, CBG.
